(19) United States
(12) Patent Application Publication
(10) Pub. No.: US 2004/0193466 A1
(43) Pub. Date: Sep. 30, 2004

(54) Method and process for managing a yard

(76) Inventors: Irena Kull, Yehud (IL); Ami Heitner, Kfar Saba (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/401,275

(22) Filed: Mar. 27, 2003

(51) Int. Cl. G06F 17/60

(52) U.S. Cl. 705/8

(57) ABSTRACT

Methods and apparatus, including computer program products, for managing a yard are described. Information associated to an object located in the yard is collected. An activity to perform on the object based on the collected information is scheduled. Execution of the scheduled activity performed on the object is monitored. Information based on the monitored execution of the scheduled activity is provided to a user.

### BACKGROUND

The present invention relates to managing a yard.

A distribution center, such as a warehouse, typically operates with a yard that is used to assist in the flow of goods in and out of the distribution center. After deposited in the warehouse, goods are often sorted and organized for distribution to an end user such as a retailer or consumer. Typically the deposited goods are labeled so warehouse personnel can sort the goods in the warehouse and be alerted, for example, to the shipping destination of the goods. Vehicles and shipping containers are typically used to transport the goods in and out of the distribution center. To transport the goods, the vehicles and shipping containers arrive and depart through the yard and in some cases shipping containers are stored in the yard prior to loading and unloading goods contained at the warehouse. While loading and unloading goods in some shipping containers, other shipping containers previously loaded or unloaded may be transported by vehicles out of the yard while other vehicles are arriving in the yard for loading and unloading other goods. Additionally, some vehicles may deliver empty containers to the distribution center for future use or to other distribution centers for use elsewhere.

### SUMMARY OF THE INVENTION

The present invention provides methods and apparatus, including computer program products, for managing a yard. Information associated to an object located in the yard is collected. An activity to perform on the object based on the collected information is scheduled. Execution of the scheduled activity performed on the object is monitored. Information based on the monitored execution of the scheduled activity is provided to a user.

One or more of the following features may be included.

The information associated to the object may include the location of the object in the yard. The location may include a yard bin in the yard. The location may include a warehouse door. The activity may include the object entering the yard. The activity may include the object exiting the yard. The activity may include moving the object in the yard. The activity may include unloading the object. Monitoring the execution of the scheduled activity may include tracing movements of the object in the yard. Monitoring the execution of the scheduled activity includes locating a position of the object in the yard. Providing the user information based on the monitored execution of the scheduled activity may include displaying information representing a movement of the object in the yard. Providing the user information based on the monitored execution of the scheduled activity may include displaying information representing the location of the object in the yard. Providing the user information based on the monitored execution of the scheduled activity may include transmitting the information on the Internet. Providing the user information based on the monitored execution of the scheduled activity may include producing a message. The object may include a shipping container. The object may include a truck. The user may include yard personnel. The user may include a carrier of the object.

The invention can provide one or more of the following advantages. The invention manages inbound/outbound transportation activities between a yard and a distribution center. By scheduling, monitoring, and reporting the activities of vehicles and shipping containers in the yard associated with the distribution center (e.g., a warehouse), the flow of goods in and out of the distribution center can be efficiently managed. Also, by managing activities in the yard, management is extended beyond the distribution center to include current status of vehicles, shipping containers, and stock in the yard and arrival and departure of vehicles and shipping containers. Additionally, by monitoring the vehicles and containers, yard personnel and other business entities can be alerted to activities being executed or not being executed during the scheduled times. Further by providing an overview of the yard and the distribution center activities, future arrivals of stock can be accordingly managed and planned.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a block diagram of a distribution system.

FIG. 2 is a block diagram of a yard management process.

FIG. 3 is a flow chart depicting a portion of a scheduling process.

FIG. 4 is a block diagram of portions of the yard management process.

FIG. 5A-B is a flow chart depicting a portion of the yard management process.

### DETAILED DESCRIPTION

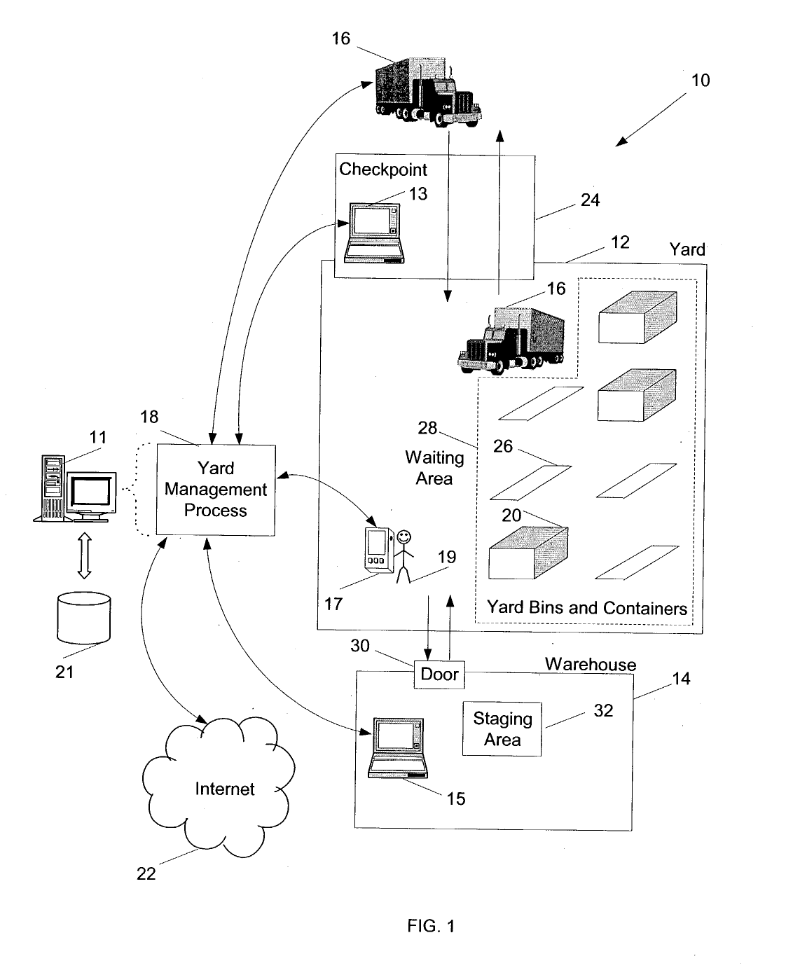

Referring to FIG. 1, a distribution system 10 includes a yard 12 that provides access to a warehouse 14 so that inbound and outbound goods can be picked-up and delivered by trucks 16 for transporting to other locations to distribute the goods. A yard management process 18, which is executed by computer 11, receives information from other computers 13, 15 respectively associated with the yard 12 and warehouse 14. The yard management process also receives information from a personal digital assistance (PDA) 17 or other similar wireless device (e.g., a cellular phone) used by yard personnel 19. However, in some arrangements, the distribution system 10 includes any combination of one or more of the computers 11, 13, 15 and the PDA 17 or other similar device. The yard management process 18 stores the information on a storage device 21 and uses the collected information to provide the yard personnel 19 using the PDA 17 and computers 11, 13, 15 with information associated to the yard 12 and the warehouse 14 for managing the movement of the trucks 16, shipping containers 20, goods contained in the shipping containers, and other objects that enter, depart, and are stored in the yard 12 and the warehouse 14. Besides collecting information associated with mobile objects (e.g., trucks, trailers, tractors, shipping containers, truck drivers, yard visitors, yard personnel, etc.), the yard management process 18 additionally collects information and monitors the status of static objects (e.g., warehouse doors, weigh stations, staging areas, yard bins, etc.) associated with the yard 12 and warehouse 14.

In this particular example the yard management process 18 is also in communication with the trucks 16 traveling to and from the yard 12 and the warehouse 14 to collect and provide information associated with the distribution system 10 to the trucks in transit. However, in some arrangements the yard management process 18 does not communicate with the trucks in transit outside of the yard 12. Additionally the yard management process 18 is in communication with Internet 22, along with other communication networks, so information associated with the distribution system 10 is transmitted to and collected from business entities (e.g., trucking companies, shipping container carriers, goods distributors, retailers, etc) to track the current status of the trucks 16 and the shipping containers 20, scheduled movements in the yard 12, and other activities associated with the distribution system 10. While trucks 16 are used to transport shipping containers 20 in and out of the yard 12, in some arrangements automobiles, trains, or other vehicles can be used individually or in combination to transport the shipping containers 20. Also, while the PDA 17 is used by yard personnel to transmit and receive information with the yard management process 18, cellular phones, telephones, or other wireless (e.g., radio frequency, infrared, etc.) or hard-wire technology may be used for communicating information.

Typically the trucks 16 enter and exit from a checkpoint 24 in the yard 12 that is a location where information is collected by the yard management process 18. This information includes the destination of the truck 16, the origination location of the truck, the contents of the shipping container(s) hauled by the truck, and whether the shipping container(s) are empty or full. After a truck 16 enters the yard 12, the truck delivers the goods to the warehouse 14 or places the shipping container 20 in a yard bin 26, located in a waiting area 28 of the yard 12 that is assigned by the yard management process 18. At a later time, as scheduled by the yard management process 18, the shipping container 20 is moved to a door 30 in the warehouse 14 in order to load or unload goods from the shipping container to or from a staging area 32 located in the warehouse 14.

By using the information collected, the yard management process 18 schedules, monitors, traces, and reports the movements of the trucks 16 and the shipping containers 20, along with other activities associated with transferring goods in and out of the yard 12. By collecting and using the collected information, yard activities are efficiently managed to reduce costs and potential conflicts such as a particular warehouse door not being open at the appropriate time to receive goods from a shipping container being stored in the yard 12. Also by providing the information onto the Internet 22, truck carriers can monitor the movements of their trucks along with the movement of the goods hauled by the trucks. Additionally, retailers can monitor the arrival and departure of goods to and from the yard 12 in order to estimate arrival times at other locations such as retail stores.

Along with monitoring checking-in and checking-out of shipping containers 20 and verifying arrivals and departures of the trucks 16, the yard management process 18 stores the scheduled destinations (e.g., a yard bin, warehouse door, etc.) of the inbound and outbound shipping containers 20. By monitoring the movements shipping containers 20, the yard management process 18 also provides constant tracking of the shipping containers 20 along with collecting information associated to the shipping containers and the goods stored in each shipping container (e.g., documents associated with each shipping container, shipping container owner/carrier information, etc). With the collected information, the yard management process 18 schedules movements and sequences of movements in the yard 12 such as moving shipping containers 20, loading and unloading shipping containers, and storing of the shipping containers in the yard bins 26. By scheduling the yard activities and collecting information associated to the execution of the activities, all the movements and yard activities associated with the shipping containers 20 are traced and monitored by a user of the yard management process 18 to improve resource management. In some arrangements the yard management process 18 can alert yard personnel if a particular event is detected or if the absence of an event occurring is detected (e.g., a particular loaded shipping container did not depart the yard at its scheduled departure time). Also in some arrangements alert messages may also be sent to users (e.g., shipping container carriers) of the yard management process 18 through the Internet 22.

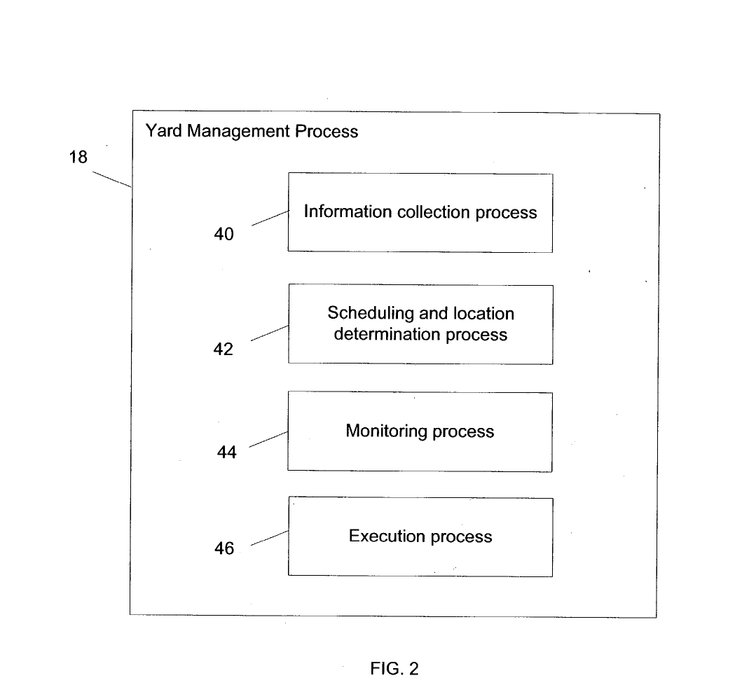

Referring to FIG. 2, the yard management process 18 includes an information collection process 40, a scheduling and location determination process 42, a monitoring process 44, and an execution process 46. The information collection process 40 receives and stores information from the computers 11, 13, 15, the PDA 17 (shown in FIG. 1), and other communication equipment at numerous locations in the distribution system 10 (shown in FIG. 1) such as the trucks, the checkpoint, the yard, the warehouse, and the Internet. In some arrangements the information collection process 40 receives information from other processes such as the Logistics Execution System (LES) that links together production, procurement, warehouse and inventory management, distribution, transportation, and sales that is produced by SAP of Walldorf, Germany and herein incorporated by reference. The scheduling and location determination process 42 allows the yard management process 18 to schedule activities (e.g., movements) associated with each warehouse door, yard bin, shipping container, or other object inside the yard with any location in the yard. Also, in some arrangements the scheduling and location determination process 42 determines and schedules operations associated with two or more yards and the movements of objects between the two or more yards along with the movements inside each yard. The monitoring process 44 allows the user of the yard management process 18 to control the handling method used to move each shipping container in the yard. The monitoring process 44 also controls the sequence of loading and unloading goods in the shipping containers. Also, the monitoring process 44 monitors the procedures for checking-in and checking-out trucks and shipping containers as they pass through the checkpoint of the yard. The monitoring process 44 also reports the collected information by transmitting information to truck carriers, shipping container carriers, or other business entities inside or outside the distribution system 10 (shown in FIG. 1). However, in some arrangements, some business entities are restricted to receiving only a portion of the collected information. The execution process 46 verifies the execution of the activities such as loading and unloading of the trucks and shipping containers. Additionally, the execution process 46 reports the location of each of the shipping containers in the yard and also reports the movements of the shipping containers in the yard and the trucks traveling inside and outside the yard.

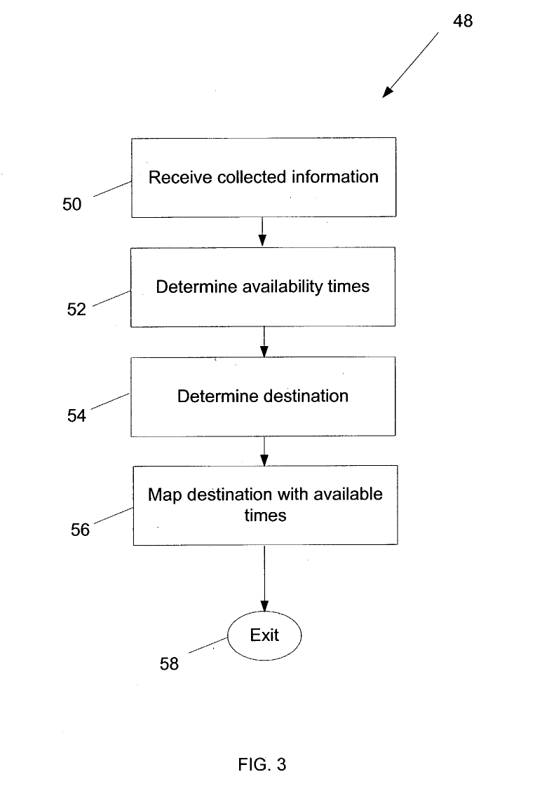

Referring to FIG. 3, a flow chart representing a portion of the scheduling and location determination process 48 is shown. The scheduling and location determination process 48 receives 50 information collected by the yard management process 18 (shown in FIG. 1). After the information is received 48, the scheduling and location determination process 48, determines 52 the availability time of a particular object in the yard 12 (shown in FIG. 1) being scheduled. For example, the scheduling and location determination process 40 schedules the operations of the warehouse door 30, the yard bins 26, or the shipping containers 20 (shown in FIG. 1). After the availability time is determined 50, the scheduling and location determination process 48 determines 54 the destination of the object being scheduled. For example, the scheduling and location determination process 48 can determine which particular shipping container, located at a particular yard bin, is to be scheduled to be moved to a warehouse door and then schedule the movement of the shipping container along with the opening and closing the particular warehouse door. After the destination is determined 54, the scheduling and location determination process 48 maps 56 the determined availability time to the determined destination and then exits 58. In some arrangements, after mapping the available times to determined locations, such as the time that a warehouse door is available to be open for loading or unloading goods from a shipping container, the information is provided to one or more personnel associated with the yard and the warehouse.

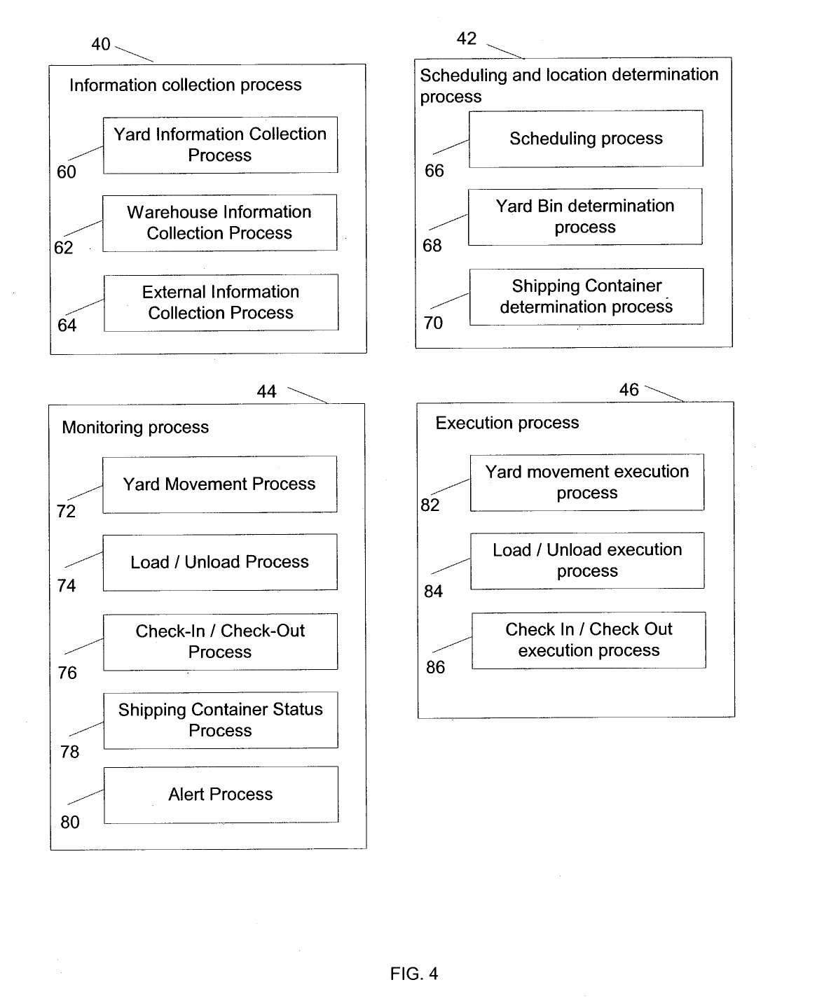

Referring to FIG. 4, the information collection process 40, the scheduling and location determination process 42, the monitoring process 44, and the execution process 46 are shown. The information collection process 40 includes a yard information collection process 60 that collects information from locations in the yard 12 (shown in FIG. 1). The yard information collection process 60 receives information from yard personnel such as the operators of the checkpoint 24 (shown in FIG. 1). The information is used by the yard management process 18 (shown in FIG. 1) in scheduling and monitoring activities associated with the checkpoint and the yard.

In some arrangements the information collection process 40 can include a database software package to store the collected information for retrieval by the processes includes in the yard management process 18 (shown in FIG. 1). Additionally the information collection process 40 can include a data sorting software package to process, sort, and format the collected information for use with the processes included in the yard management process 18 (shown in FIG. 1). In some arrangements the operators and yard personnel enter the information into a computer system, telephone, cellular phone, personal digital assistant (PDA), or other similar device that is in communication with the yard information collection process 60 though a hard wire connection or a wireless link. The information collection process 40 also includes a warehouse information collection process 62 that collects information from the warehouse 14 (shown in FIG. 1). Warehouse personnel transmit information such as the arrival and departure of shipping containers to and from the warehouse, the status of the warehouse doors and staging areas, and other information associated to the movement of goods in and out of the warehouse. Similar to the yard information collection process 60, information collected by the warehouse collection process 62 can be transmitted by using hard wire technology (e.g., a hard wire computer network, a land line telephone, etc.) or by using wireless technology (e.g., cellular technology, radio frequency technology, etc.). Additionally, in some arrangements the warehouse collection process 62 uses one or more database software packages to collection, sort, format information for transmission and storage. The information collection process 40 also includes an external information collection process 64 that collects information from entities not located in the yard 12 (shown in FIG. 1) or in the warehouse 14 (also shown in FIG. 1). The external information collection process 64 collects information from trucks that are in route to the yard or have exited the yard and are in route to another location. The external information collection process 64 also collects information from business entities over the Internet 22 (shown in FIG. 1) or from one or more processes executed on the same or different computer. For example, information is collected from the Logistics Execution System so that future scheduling of the yard and the warehouse can be done prior to trucks and shipping containers arriving.

Since the scheduling and location determination process 42 determines and schedules activities associated with the objects in the yard and any location within of the yard and the warehouse, the scheduling and location determination process includes processes associated with certain objects (e.g., shipping containers, yard bins, etc.) and locations (e.g., warehouse doors, staging areas, etc.) of the yard for determining and scheduling associated activities. In this particular example the scheduling and location determination process 42 includes but is not limited to, processes associated with scheduling activities associated with the yard, the warehouse, and objects (e.g., shipping containers) associated with the yard and warehouse. The scheduling and location determination process 42 includes a scheduling process 66 that uses the entered information to schedule activities associated with the yard 12 including scheduling activities associated with objects (e.g., shipping containers) in the yard and yard locations (e.g., warehouse doors). For example, the scheduling process 66 can assign shipping containers to one or more warehouse doors and staging areas of the warehouse 14 (also shown in FIG. 1) for loading and unloading the assigned shipping containers at an appropriate warehouse door and at an appropriately scheduled time. When preparing a schedule for a particular yard location, such as a warehouse door, the scheduling process 66 can use physical characteristics (i.e., compare the physical characteristics of the door with the physical characteristics of the shipping containers), the operation to be performed at the door (e.g., receiving only, shipping only, both shipping and receiving, etc.), the geographical location of the door in relation to the warehouse storage types, if a group of doors is needed, the load/unloading equipment that is needed, the relationship of the door and the staging area, etc. The scheduling process 66 also uses the physical type of the shipping container and the contents of the shipping container in determining scheduling. For example, the scheduling process 66 can use information that the contents of a particular shipping container is restricted to particular warehouse doors (e.g., security reasons, temperature controlled contents, etc.) for loading or unloading. Loading and unloading duration time can also be used by the scheduling process 66 to select the particular warehouse door for a shipping container. The scheduling process 66 can also receive information associated to the particular equipment needed to open or close the shipping container. Also information that provides the status of the shipping containers (e.g., whether the container is damaged, ownership of the container, etc) can also be received by the door scheduling process for assigning the shipping containers to warehouse doors and scheduling the warehouse doors to open and close for loading and unloading goods.

After the scheduling process 66 assigns a shipping container to a warehouse door, staging area, or any other yard location, the process allows a user to override the particular selection made. The scheduling process 66 can also use the information collected to schedule one or more staging areas in the warehouse for loading and unloading operations. The scheduling of the staging area is typically driven by the selection of the warehouse door, however in some arrangements a staging area can be pre-selected based on previously scheduled loading or unloading operations (i.e., cross docking). The scheduling process 66 also provides the status of the scheduling process (e.g., a ‘planned’ state when a shipping container is in transit, a ‘firm’ state when the shipping container is checked-in the yard, etc.). The scheduling process 66 is provided with the arrival times and a time estimation of the loading or unloading of the shipping container to determine the appropriate scheduling times. Also, delays due to traffic (inside and outside the yard) and unexpected delays during unloading and loading can be collected and used by the scheduling process 66. The scheduling process 66 can also provide a user with a report such as a Gantt chart overview that displays a planned schedule of the yard locations at appropriate time intervals.

The scheduling and location determination process 42 also includes a yard bin determination process 68 that is used to determine which particular shipping container is positioned in a particular yard bin and for what period of time (e.g., less than an hour, several hours, several days, etc.). To schedule the yard bins 20 (shown in FIG. 1) in the yard 12 (also shown in FIG. 1) the yard bin determination process 68 uses collected information such as the shipping container type, the contents of the shipping container, and the geographic location of the yard bin and the one or more warehouse doors that are to be accessed to load or unload the shipping container. The collected information used by the yard bin determination process 68 also includes the particular carrier associated with the shipping container, whether the shipping container is full, empty, or partially full, whether the shipping container is inbound to or outbound from the yard, the warehouse door or group of warehouse doors to be accessed (if known), and the expected waiting time (if known) of the shipping container. Also in making the yard bin scheduling determinations, the yard bin determination process 68 also uses collected information associated to the capacity (e.g., unlimited, number of shipping container types per yard bin type, etc.) of the yard bin, the availability of the yard bins, and if a particular yard bin has been reserved by a carrier or yard personnel. Information associated with geographical grouping of the yard bins and the one or more destination warehouse doors is also be used by the yard bin determination process 68. Relationships between container content, preferred storage types, staging areas, warehouse doors and yard bins is also be used by the yard bin determination process 68. Similar to the scheduling process 66, the yard bin determination process 68 is capable of manual overriding by a user (e.g., yard personnel).

The scheduling and location determination process 42 also includes the shipping container determination process 70 that selects the particular shipping container to move, for example, from the waiting area 28 (shown in FIG. 1) of the yard 12 (also shown in FIG. 1) to a particular warehouse door 30 (also shown in FIG. 1) selected by the scheduling process 66 at the appropriately scheduled time. To determine scheduling of shipping container movements the shipping container determination process 70 uses a number of parameters collected by the information collection process 40. For example, specific requirements for other yard and warehouse processes (e.g., cross docking in the yard, stock demand, etc.) are used. The shipping container determination process 70 uses the time a particular shipping container has been stored in the yard in scheduling movements. For example, in the United States a carrier can typically expect to get their shipping containers within 48 hours. The shipping container determination process 70 also assigns a priority to a shipping container, for example, a shipping container in the yard may be assigned a priority internally by yard personnel or externally by an external system. The shipping container determination process 70 also receives and uses information associated to the contents of a shipping container, ownership of the shipping container, age and expiration of the goods held by the shipping container, etc. Typically, when a container is selected for movement from the yard to the warehouse, a movement instruction is produced by the shipping container determination process 70. Upon the container being received at the scheduled warehouse door, the contents of the container are identified then necessary loading or unloading is performed and a document (e.g., a set of transfer orders) is produced.

The monitoring process 44 includes a yard movement process 72 that determines the destination for a particular shipping container and the particular type of vehicle to move the container to the destination. For example, if the shipping container is being moved from the checkpoint 24 (shown in FIG. 1) to a yard bin or a warehouse door, the hauling vehicle, i.e., truck 16 (shown in FIG. 1), is used to move the shipping container. If the shipping container is to be moved to a warehouse door from a yard bin or another warehouse door, a yard vehicle (e.g., a tractor) is used to move the shipping container. If a shipping container is to move to a yard bin from a warehouse door or from another yard bin, a yard vehicle is used to move the container. In still another example, if a shipping container is to move to the checkpoint 24 in order to exit the yard, the truck 16 is typically used for the movement. However, in some arrangements yard personnel determine which particular type of vehicle is used to move a shipping container from one location to another location associated with the yard 12, warehouse 14, and checkpoint 24 (all shown in FIG. 1). Along with determining the resources and destinations to move the shipping containers, the yard movement process 72 also reports each movement task to yard personnel by producing a document (e.g., a report that indicates the movement instruction) or by transmitting the movement task information by using radio frequency (RF) technology, the Internet 22 (shown in FIG. 1), cellular phone technology, or some other similar wireless or hardwire technology.

The monitoring process 44 also includes a load/unload process 74 that provides a link between yard management and warehouse management. Typically the load/unload process 74 is performed prior to or after the completion of processes that manage the warehouse 14 (shown in FIG. 1) and may be dependent upon the type of warehouse management performed. The load/unload process 74 is associated with the physical operations of loading and unloading the shipping containers by performing the initial verification of the goods received at the warehouse and the final verification that the appropriate goods are being shipped. The load/unload process 74 also receives information to verify the appropriate loaded and unloaded trucks are used (e.g., sealing number introduction). The load/unload process 74 also provides the yard personnel with the particular sequence for unloading and loading the shipping containers along with other associated information. Typically the load/unload process 74 uses wireless network technology (e.g., RF devices, cell phones, etc.) or hardwire network technology (e.g., a computer, a computer network, etc.) to deliver the loading or unloading sequence and other associated information.

The monitoring process 44 also includes a check-in/check-out process 76 that uses information collected at the checkpoint 24 (shown in FIG. 1) of the yard 12 (also shown in FIG. 1) and also provides information to the checkpoint. Typically the information used by the check-in/check-out process 62 is entered into the yard information collection process 60 by an operator of the checkpoint from documents (e.g., inbound and outbound shipment documents, inbound and outbound deliver documents, transfer orders for internal warehouse movements, etc.) that are used by the yard, warehouse, and truck carriers to introduce shipping containers to the distribution system 10 (shown in FIG. 1). In some arrangements the check-in/check-out process 76 filters information provided by some of the documents based on project-specific requirements. The check-in/check-out process 76 also determines whether newly arrived shipping container(s) go directly to a warehouse door, as provided by the scheduling process 66, or if the newly arrived shipping container(s) are to wait in waiting area 28 (shown in FIG. 1) of the yard 12 (also shown in FIG. 1) in a particular yard bin, as provided by the yard bin determination process 68. The check-in/check-out process 76 process makes this determination based on information provided by the documents associated to the shipping container, information located on the shipping container, project-specific information, or a combination of the this information.

The check-in/check-out process 76 also uses the collected information to register the shipping container and the associated vehicle (e.g., the truck) transporting the shipping container. Through registration, the collected information controls the arrival and departure of the vehicle and the shipping container. Typically, registration is preformed during inbound and outbound movements of the shipping containers at the checkpoint 24 (shown in FIG. 1). Also through registration, information is collected to address security concerns, carrier schedules, and vendor quality analysis. Typically the collected information includes hauling vehicle information (e.g., license plate numbers, carrier/transporter identification, driver identification, etc.), shipping container identification (e.g., standard carrier alpha code (SCAC) designation), transponder identification, shipping container contents and associated information (e.g., deliveries made, weight, etc), arrival information (e.g., schedule, priority information, arrival date and time), and optional yard destination information (e.g., warehouse door, yard bin, etc.).

The check-in/check-out process 76 also includes checking one or more documents associated with registration. For example, the shipment (i.e. transportation) documents, inbound and outbound delivery documents, or other similar documents associated with registration may be checked. In some arrangements, the check-in/check-out process 76 also includes checking individually or in combination Bills of lading, security checks (e.g., verifying return authorization numbers), and weight checks (e.g., measuring the weight at arrival and departure and verifying differences based on loading and unloading information from the warehouse).

The check-in/check-out process 76 is used during arrival and departure. For example, one or more shipping containers arrive for unloading inbound goods or one or more shipping containers arrive for loading outbound goods. In still another example, a hauling vehicle arrives to pick up one or more full or empty shipping containers. Also, as a hauling vehicle is departing the yard 12 (shown in FIG. 1) through the checkpoint 24 (also shown in FIG. 1) the check-in/check-out process 76 collects information associated with the next destination of the vehicle. Correspondingly, the check-in/check-out process 76 collects information from numerous departure scenarios. For example, one or more shipping containers can be departing with outbound goods. In another example, one or more empty shipping containers, carried by a hauling vehicle depart after unloading inbound goods at the warehouse. In still another example, a hauling vehicle departs without any shipping containers after depositing one or more empty or full shipping containers.

The monitoring process 44 includes a shipping container status process 78 that uses collected information to address maintaining and reviewing the shipping containers 20 (shown in FIG. 1) in the yard 12 (also shown in FIG. 1) by yard personnel. The collected information is used in planning and scheduling activities involving the shipping containers. Some of the collected information used for shipping container review and maintenance includes information associated with the hauling vehicles used to transport the shipping container, shipping container identification, SCAC designations, sealing numbers, assigned reference documents, priority assigned to the shipping container, shipping container location, arrival/departure time, ownership of the shipping container, shipping container type, block indicator with a reason code, remaining time in yard, and the status of a content indicator for determining if goods have expired (e.g., safe consumption time for goods).

The shipping container status process 78 also collects and maintains an internally assigned yard status of the shipping containers that include a status such as ‘in transit’, ‘checked-in’, ‘in the yard’, ‘at the warehouse door’, ‘load/unload started’, ‘load/unload finished’, ‘ready to be picked-up’, and ‘checked-out’. As the shipping containers proceed through the various activities and processes associated with the yard management process 18 (shown in FIG. 1), the status of the individual shipping containers is changed to alert the yard personnel to the current state of the shipping containers.

The monitoring process 44 also includes an alert process 80 that provides alerts to the yard personnel and/or to another users such as the carriers of the shipping containers. In some arrangements the alert process 80 provides a graphical image of the yard and uses the image to alert a user (e.g., yard personnel) to a particular location or operation being performed in error. For example, the image alerts the yard personnel that a particular shipping container is being unloaded at an inappropriate time or that a particular truck is about to depart the yard with the wrong shipping container.

In some arrangements, the alert process 80 also accesses the collected information associated to the shipping containers, hauling vehicles (e.g., trucks 16), yard equipment (e.g., tractors), and other similar objects associated to the yard 12 (shown in FIG. 1). This collected information includes the location of the yard objects and the status of the objects, for example, as provided by the shipping container status process 78 (e.g., the shipping container is being loaded or unloaded). By sorting and organizing this collected information, the alert process 80 provides a list of locations that each yard object (e.g., a shipping container) was located at any particular time and the operations performed on the object at each location (e.g., loading, unloading, etc.).

Additionally, in some arrangements, the alert process 80 provides information associated to the distribution system 10 (shown in FIG. 1) to users and communication/information systems (e.g., a company computer network) external to the distribution system. The alert process 80 can inform the users and communication/information systems by transmitting a message (e.g., a fax, a short message service page, an email, etc.) when a predefined event is detected (e.g., a status change of a shipping container). In some arrangements the message is sent over the Internet 22 (shown in FIG. 1) or some other communication system to inform a user such as the carrier of the shipping container. The alert process 80 also provides an access point for truck carriers, truck owners, and other external business entities to retrieve and review information associated to trucks and the shipping containers being hauled. The information the carrier can access through the alert process 80 includes the truck identification, the shipping container identification and SCAC number, arrival date and time, departure date and time, information associated with arrivals and departures (e.g., driver identification, outbound content, destination, etc.), whether or not the shipping container is ready for pick-up (either empty or loaded), contents and destination of the shipping container if the container is full, and any reassignment of inbound shipments to outbound shipments.

In some arrangements the alert process 80 provides access to this information for a shipping container carrier through a secure or non-secure Internet address such that the carrier can log into the Internet address and retrieve this collected information. Also in some arrangements the same information available through the shipping container status process 78 is also available to the shipping carriers by using the alert process 80. For example, a carrier retrieves the status of a particular shipping container to determine if the container is ‘in transit’, ‘checked-in’, ‘in the yard’, ‘at the warehouse door’, ‘load/unload started’, ‘load/unload finished’, ‘ready to be picked-up’, or ‘checked-out’. However, in some arrangements the information available to the shipping carriers outside of the distribution system 10 (shown in FIG. 1) is a subset, or different from the information available to the personnel of the yard and the warehouse of the distribution system. For example, the alert process 80 may only provide information that a particular shipping container is ‘in transit’ to or from the yard, if the shipping container is ‘being processed’ in the yard, or if the shipping container is ‘available’ and ready for picking up.

The execution process 46 includes, but is not limited to, a yard movement execution process 82, a load/unload execution process 84, and a check-in/check-out execution process 86. Each of the included processes 82, 84, 86 provides instructions for the yard personnel to execute one or more tasks associated with the respective process. For example, the yard movement execution process 82 provides instructions to the yard personnel for moving a particular object (e.g., a shipping container) that is scheduled to be moved to a particular location in the yard (e.g., a warehouse door). Also, in another example, the load/unload execution process 84 provides the yard personnel with instructions such as whether a particular shipping container, truck, or other object in the yard is to be loaded or unloaded and the associated contents. The check-in/check-out execution process 86 provides the yard personnel with instructions to follow for checking a truck through the checkpoint 24 (shown in FIG. 1) and into or out of the yard. Additionally, the yard movement execution process 82, the load/unload execution process 84, and the check-in/check-out execution process 86 provide information back to the yard management process 18 (shown in FIG. 1). The information provides the status of the one or more associated tasks performed by the yard personnel. For example, the yard movement execution process 82 provides information such as if a scheduled movement has been initiated, if the movement has been delayed, if the movement has been completed, or other similar type of status information. In some arrangements the load/unload execution process 84 also provides a loading or unloading status to the yard management process 18. Also, the check-in/check-out execution process 86 provides the status of a particular truck that is passing through the checkpoint 24 (shown in FIG. 1). For example, the check-in/check-out execution process 86 informs the yard management process 18 if the particular truck has arrived at the scheduled time, departed at the scheduled time, or other similar condition of the truck at the checkpoint.

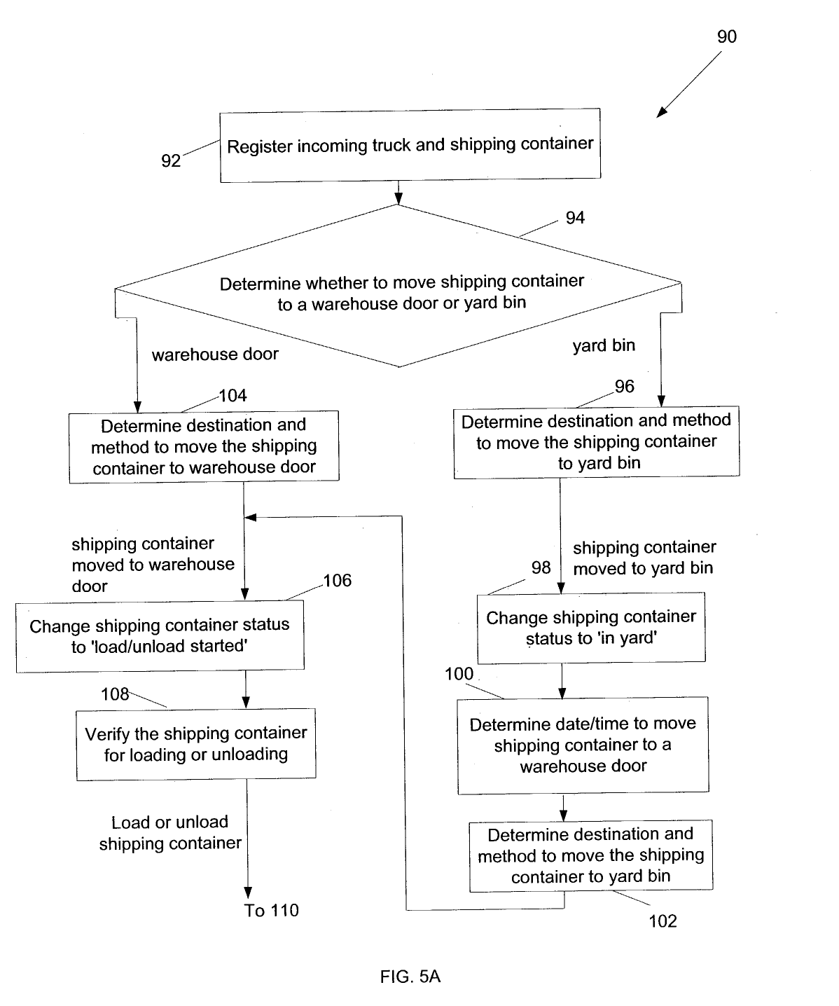

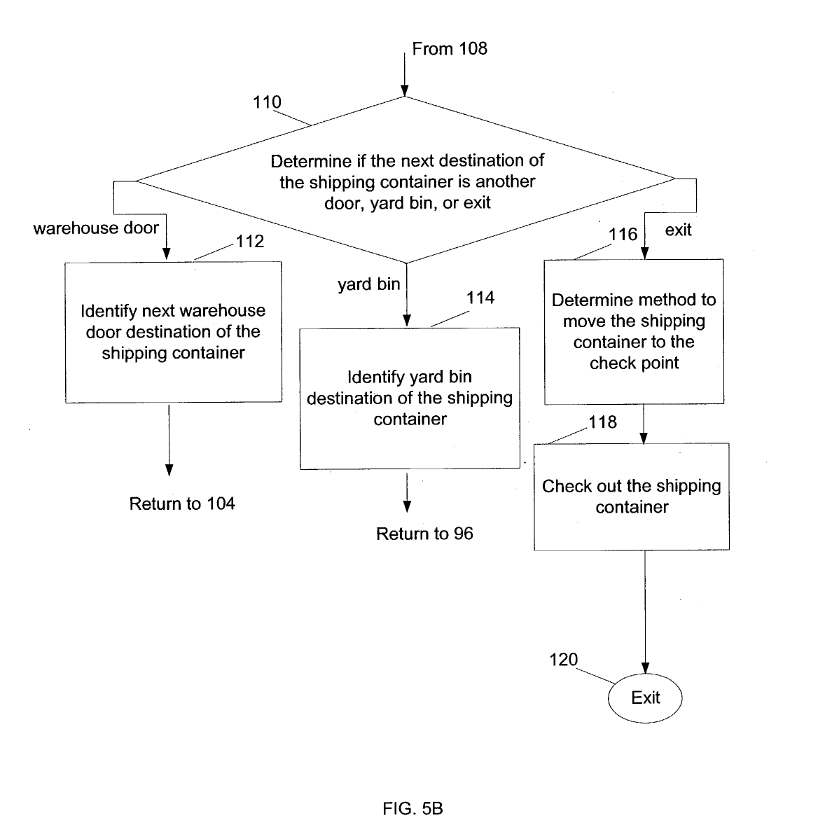

Referring to FIG. 5A-B, a flow chart representing a portion of a yard management process 90 is shown. The yard management process 90 registers 92 an incoming truck, which arrives at the checkpoint 24 (shown in FIG. 1) of the yard 12 (also shown in FIG. 1) and includes a shipping container. Typically, the registering 72 is accomplished, by using the check-in/check-out process 76 (shown in FIG. 4) and the check-in/check-out execution process 86 (also shown in FIG. 4). This registration is typically based on a reference document or on the arrival of the truck. During the registering of the truck, information associated to the shipping container and truck is collected by the information collection process 40 (shown in FIG. 4). After registering 72 the truck and shipping container, the yard management process 90 determines 94 whether to move the shipping container to a particular warehouse door or whether to move the shipping container to a particular yard bin 20 (shown in FIG. 1) in the waiting area 28 (also shown in FIG. 1). In some arrangements the scheduling and location determination process 42 (shown in FIG. 4) is used in the determination. If the shipping container is to be directed to a yard bin in the waiting area, the yard management process 90 determines 96 an appropriate destination and method (e.g., whether to use the hauling truck or a yard tractor) to move the shipping container. In some arrangements the yard management process 90 uses the destination determination process 68 (shown in FIG. 4) to determine the appropriate destination and the yard movement process 72 to determine the appropriate method. However, in some arrangements yard personnel determine the appropriate method and inform the yard management process 90 with the yard movement execution process 82 (shown in FIG. 4). After the appropriate destination and method is determined 96, the shipping container is moved to the yard bin and the yard management process 90 changes 98 the status of the shipping container to ‘in yard’. After the status of the shipping container has been changed 98, the yard management process 90 determines 100 the date and time to move the shipping container from the yard bin to a warehouse door. Typically, the scheduling and location determination process 42 (shown in FIG. 4) is used to determine this time and date. After the date and time has been determined 100 and the appropriate date and time has arrived, the yard management process 90 determines 102 an appropriate destination and method (e.g., whether to use the hauling truck or a yard tractor) to move the shipping container. In some arrangements the yard management process 90 uses the destination determination process 68 (shown in FIG. 4) to determine the appropriate destination and the yard movement process 72 to determine the appropriate method. However, in some arrangements yard personnel determine the appropriate method and inform the yard management process 90 with the yard movement execution process 82 (shown in FIG. 4). Similarly, if determined 94 to move the shipping container to a warehouse door, the yard management process 90 determines 104 the destination and method to move the shipping container to the warehouse door. After the respective determinations are made, the shipping container is moved to the appropriate warehouse door with the appropriate equipment.

Upon arriving at the appropriate warehouse door, yard management process 90 changes 106 the status of the shipping container to ‘load/unload started’. Typically, the load/unload process 106 (shown in FIG. 4) is used to change the status. After the status of the shipping container is changed 106, the yard management process 90 verifies 108 the appropriate shipping container has been brought to the appropriate warehouse door, for example, by using the load/unload execution process 84 (shown in FIG. 4). After the shipping container is verified 108 the shipping container is loaded or unloaded. After the container is loaded or unloaded the yard management process 90 determines 110 if the next destination of the shipping container is, for example, another warehouse door, a yard bin, the checkpoint 24 to exit the yard, or any other location in yard. Typically to make the determination the yard management process 110 uses the scheduling and location determination process 42 (shown in FIG. 4). If the next destination of the shipping container is another warehouse door, the yard management process 90 identifies 112 the next warehouse door and returns to determine 104 the destination and method to move the shipping container and continues. Typically the yard management process 90 uses the scheduling and location determination process 42 to identify the warehouse door.

If the next destination of the shipping container is a yard bin in the waiting area of the yard, the yard management process 90 identifies 114 the particular yard bin to receive the shipping container. Typically, the yard management process 90 uses the scheduling and location determination process 42 (shown in FIG. 4) to identify the particular yard bin. After identifying the yard bin, the yard management process 90 returns to determine 96 the destination and method to move the shipping container to the yard bin and then continues.

If the next destination of the shipping container is outside of the yard, the yard management process 90 determines 116 the method to move the shipping container to the checkpoint 24 (shown in FIG. 1), for example, by using the yard movement process 72 (shown in FIG. 4). However, in some arrangements yard personnel determine the method to move the shipping container and report the method to the yard management process 90 by using, for example, the yard movement execution process 82 (shown in FIG. 4). After determining 116 the method to move the shipping container, the yard management process 90 checks out 118 the shipping container at the checkpoint 24 of the yard, for example, by using the check-in/check-out execution process 86 (shown in FIG. 4). After the shipping container is checked out 118, the yard management process 90 exits 120 to perform other functions such as alerting the shipping container's carrier that the container has departed the yard.

To trace the movements of the shipping container among the check point, the yard bins, and the warehouse doors, yard personnel can use the alert process 80 (shown in FIG. 4) to view a graphical display that represents the movements of the shipping container along with the locations that the shipping container to moved (e.g., a particular yard bin, a particular warehouse door, the check point, etc) based on information collected at each location. In some arrangements, the graphical display is provided by the alert process 80 (shown in FIG. 4), along with the other information associated to the shipping container and yard, can be transmitted by the alert process 80 (shown in FIG. 4) to the Internet 22 (shown in FIG. 1) so that a shipping container carrier, or other business entity located outside the distribution system 10 (shown in FIG. 1), can view the graphical display to monitor the location and movements of the shipping container. Also, in some arrangements, the information communication system restricts information provided to entities not included in the distribution system 10. For example, a shipping container carrier is restricted to only view information that is associated to the shipping containers owned by the shipping container carrier.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods can be performed by one or more programmable processors executing a computer program to perform functions of the invention by operating on input data and generating output. The method can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for managing a yard, the method comprises:
collecting information associated to an object located in the yard;
scheduling an activity to perform on the object based on the collected information;
monitoring execution of the scheduled activity performed on the object; and
providing a user information based on the monitored execution of the scheduled activity.

2. The method of claim 1 wherein the information associated to the object includes the location of the object in the yard.

3. The method of claim 2 wherein the location includes a yard bin in the yard.

4. The method of claim 2 wherein the location includes a warehouse door.

5. The method of claim 1 wherein the activity includes the object entering the yard.

6. The method of claim 1 wherein the activity includes the object exiting the yard.

7. The method of claim 1 wherein the activity includes moving the object in the yard.

8. The method of claim 1 wherein the activity includes unloading the object.

9. The method of claim 1 wherein monitoring execution of the scheduled activity includes tracing movements of the object in the yard.

10. The method of claim 1 wherein monitoring execution of the scheduled activity includes locating a position of the object in the yard.

11. The method of claim 1 wherein the providing the user information based on the monitored execution of the scheduled activity includes displaying information representing a movement of the object in the yard.

12. The method of claim 1 wherein the providing the user information based on the monitored execution of the scheduled activity includes displaying information representing the location of the object in the yard.

13. The method of claim 1 wherein the providing the user information based on the monitored execution of the scheduled activity includes transmitting the information on the Internet.

14. The method of claim 1 wherein the providing the user information based on the monitored execution of the scheduled activity includes producing a message.

15. The method of claim 1 wherein the object includes a shipping container.

16. The method of claim 1 wherein the object includes a truck.

17. The method of claim 1 wherein the user includes yard personnel.

18. The method of claim 1 wherein the user includes a carrier of the object.

19. A process for managing a yard, the system comprising:
a collection process for collecting information associated to an object located inside the yard;
a scheduling process for scheduling an activity to perform on the object based on the collected information;
a monitoring process for monitoring execution of the scheduled activity performed on the object; and
a reporting process for providing a user information based on the monitored execution of the scheduled activity.

20. The process of claim 19 wherein the information associated to the object includes the location of the object in the yard.

21. The process of claim 20 wherein the location includes a yard bin in the yard.

22. The process of claim 20 wherein the location includes a warehouse door.

23. The process of claim 19 wherein the activity includes the object entering the yard.

24. The process of claim 19 wherein the activity includes the object exiting the yard.

25. The process of claim 19 wherein the activity includes moving the object in the yard.

26. The process of claim 19 wherein the activity includes unloading the object.

27. The process of claim 19 wherein the monitoring process includes a tracing process for tracing movements of the object in the yard.

28. The process of claim 19 wherein monitoring execution of the scheduled activity includes locating a position of the object in the yard.

29. The process of claim 19 wherein the reporting process includes displaying information representing a movement of the object in the yard.

30. The process of claim 19 wherein the reporting process includes displaying information representing the location of the object in the yard.

31. The process of claim 19 wherein the reporting process includes transmitting the information on the Internet.

32. The process of claim 19 wherein the reporting process includes producing a message.

33. The process of claim 19 wherein the object includes a shipping container.

34. The process of claim 19 wherein the object includes a truck.

35. The process of claim 19 wherein the user includes yard personnel.

36. The process of claim 19 wherein the user includes a carrier of the object.

37. A computer program product, tangibly embodied in an information carrier, for storing instructions for managing a yard, the computer program product being operable to cause data processing apparatus to:
collect information associated to an object located in the yard;
schedule an activity to perform on the object based on the collected information;
monitor execution of the scheduled activity performed on the object; and
provide a user information based on the monitored execution of the scheduled activity.

38. The computer program product of claim 37 wherein the information associated to the object includes the location of the object in the yard.

39. The computer program product of claim 38 wherein the location includes a yard bin in the yard.

40. The computer program product of claim 38 wherein the location includes a warehouse door.

41. The computer program product of claim 37 wherein the activity includes the object entering the yard.

42. The computer program product of claim 37 wherein the activity includes the object exiting the yard.

43. The computer program product of claim 37 wherein the activity includes moving the object in the yard.

44. The computer program product of claim 37 wherein the activity includes unloading the object.

45. The computer program product of claim 37 wherein to monitor execution of the scheduled activity includes tracing movements of the object in the yard.

46. The computer program product of claim 37 wherein to monitor execution of the scheduled activity includes locating a position of the object in the yard.

47. The computer program product of claim 37 wherein to provide the user information based on the monitored execution of the scheduled activity includes displaying information representing a movement of the object in the yard.

48. The computer program product of claim 37 wherein to provide the user information based on the monitored execution of the scheduled activity includes displaying information representing the location of the object in the yard.

49. The computer program product of claim 37 wherein to provide the user information based on the monitored execution of the scheduled activity includes transmitting the information on the Internet.

50. The computer program product of claim 37 wherein to provide the user information based on the monitored execution of the scheduled activity includes producing a message.

51. The computer program product of claim 37 wherein the object includes a shipping container.

52. The computer program product of claim 37 wherein the object includes a truck.

53. The computer program product of claim 37 wherein the user includes yard personnel.

54. The computer program product of claim 37 wherein the user includes a carrier of the object.
